(19) United States
(12) Patent Application Publication
(10) Pub. No.: US 2005/0270911 A1
(43) Pub. Date: Dec. 8, 2005

(54) Optical disk apparatus and address detection method

(76) Inventors: Yutaka Kashihara, Chigasaki-shi (JP); Tadashi Kojima, Yokohama-shi (JP); Akihito Ogawa, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/143,999

(22) Filed: Jun. 3, 2005

(30) Foreign Application Priority Data
Jun. 7, 2004 (JP) 2004-169093

(51) Int. Cl. G11B 5/09; G11B 7/24

(52) U.S. Cl. 369/30.01; 369/275.4; 369/47.31; 369/59.1

(57) ABSTRACT

An optical disk apparatus comprises a Gray code detector for detecting a Gray code of a track address, a position detector for detecting, as an address uncertain position, a least significant bit of the detected Gray code of the track address and a bit of the detected Gray code of the track address and is higher by one than a bit position of a least significant code bit “1”, and a replacing unit which replaces a bit at the address uncertain position of the land address with a bit at a corresponding position of the groove address of the same track, and replaces a bit at the address uncertain position of the groove address with a bit at a corresponding position of the land address of the same track.

### CROSS-REFERENCE TO RELATED APPLICATIONS

This application is based upon and claims the benefit of priority from prior Japanese Patent Application No. 2004-169093, filed Jun. 7, 2004, the entire contents of which are incorporated herein by reference.

### BACKGROUND OF THE INVENTION

1. Field of the Invention

The present invention relates generally to a process of reproducing address information from a recordable optical disk, and more particularly to an optical disk apparatus and an address detection method with enhanced reliability in address data detection.

2. Description of the Related Art

Data is spirally recorded on an optical disk. In order to enable an optical head to exactly trace the spiral tracks at a time of recording or reproduction, guide grooves are pre-recorded on the recordable optical disk. The grooves that are pre-recorded are wobbled at predetermined cycles. At the time of reproduction, the wobble cycle is measured to detect a scanning speed. Thus, a clock signal that is synchronized with the rotational speed can be obtained (see, e.g. Jpn. Pat. Appln. KOKAI Publication No. 2001-266352 (Paragraph 0003)).

Of the recordable media, CD-R/RWs, DVD-R/RWs and DVD+R/RWs adopt a groove recording scheme in which data is recorded on groove tracks alone. However, in order to achieve high-density recording, a land & groove recording scheme, in which data is recorded on both the land track and groove track, has been developed and adopted in DVD-RAMs.

Besides, on the recordable optical disk, address data needs to be pre-recorded. Prior to recording data, the optical disk apparatus reproduces address data, specifies a position on the optical disk on the basis of the reproduced address data, and records data at the specified position. Address data recording methods include a pre-pit method in which pits are pre-formed on the track, and a wobble modulation method in which grooves are modulated in accordance with address data. The pre-pit method is adopted on DVD-R/RWs and DVD-RAMs, and the wobble modulation method is adopted on CD-R/RWs and DVD+R/RWs. In the pre-pit method, a record signal has information at an edge portion thereof, so the reliability tends to be low. It is thus preferable to record address data by the wobble modulation method. Hence, a method (wobble modulation method) has been considered, wherein a groove is not wobbled with a single cycle but address data is recorded as wobbles by subjecting the wobbles to phase modulation or frequency modulation.

In recent years, there has been proposed an optical disk, wherein data is recorded by the land & groove recording method and track addresses are recorded by the wobble modulation scheme.

However, if address data is to be recorded by the wobble modulation scheme on the land & groove recording-type optical disk, the following drawback arises. In the land & groove recording method, data is recorded on both land tracks and groove tracks. Consequently, the neighboring land track and groove track have common side walls. There are some parts where the inner peripheral wall and outer peripheral wall of the land track/groove track have different wobble phases, and the track width of the land track/groove track may vary. If the track width varies, a total reflection area for a read beam varies. Consequently, a DC offset occurs in the detected wobble signal (address data), and a detected RF signal (recorded data reproduction signal) has a waveform that wobbles due to the wobble signal. In the description below, the position where both wall surfaces of the track have different phases is referred to as “track width variation position”, “address data uncertain position” or “RF signal wobble position”.

As stated above, if address data is recorded by wobble modulation method on the land & groove recording-type optical disk, there occur some locations where the track width varies, and the RF signal wobbles. It is thus difficult to correctly read out the address data.

### BRIEF SUMMARY OF THE INVENTION

The object of the present invention is to provide an optical disk apparatus and an address detection method, which are capable of correctly reproducing address data from a land & groove recording-type optical disk on which address data is recorded by a wobble modulation method.

According to an embodiment of the present invention, an optical disk apparatus which detects a track address from an optical disk of a land & groove recording type, on which a Gray code of a track address that includes a land address and a groove address is wobble-modulated and recorded, the apparatus comprises Gray code detection means for detecting the Gray code of the track address; position detection means for detecting, as an address uncertain position, one of a least significant bit of the Gray code of the track address that is detected by the Gray code detection means and a bit of the Gray code of the track address that is detected by the Gray code detection means and is higher by one than a bit position of a least significant code bit “1”; and means for replacing a bit at the address uncertain position of the land address, which is detected by the position detection means, with a bit at a corresponding position of the groove address that is recorded on the same track, and replacing a bit at the address uncertain position of the groove address, which is detected by the position detection means, with a bit at a corresponding position of the land address that is recorded on the same track.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 shows a relationship between code bits of address data and wobble phases when address data is recorded by a wobble modulation method;

FIG. 2 illustrates a variation in track width due to a difference in wobble phase between an inner circumferential wall surface and an outer circumferential wall surface of a land (groove) track;

FIG. 3A shows states of a wobble signal and a data reproduction signal in a case where both wall surfaces of the track have the same phase;

FIG. 3B shows states of a wobble signal and a data reproduction signal in a case where both wall surfaces of the track have different phases;

FIG. 4 shows a format of an optical disk (relationship between zones, tracks and physical segments);

FIG. 5 shows a layout of address data (WAP) that is assigned to physical segments;

FIG. 6 shows a layout of an address field in address data (WAP);

FIG. 7 shows a layout of wobble data units (WDU) in a sync field in the address data (WAP);

FIG. 8 shows a layout of wobble data units (WDU) in the address field in the address data (WAP);

FIG. 9 shows a layout of wobble data units (WDU) in a unity field in the address data (WAP);

FIG. 10 illustrates bit modulation rules of address data;

FIG. 11 shows a layout of a record cluster;

FIG. 12 shows a layout of a data segment;

FIG. 13 shows a layout of linking;

FIG. 14 shows an example of wobble modulation;

FIG. 15 shows a temporal correlation of address uncertain positions;

FIG. 16 illustrates conversion from binary codes to Gray codes;

FIG. 17 illustrates features of Gray codes;

FIG. 18A shows a binary code/Gray code conversion circuit;

FIG. 18B show a Gray code/binary code conversion circuit;

FIG. 19 shows a relationship between address uncertain positions and address data numbers (binary codes) in a case where Gray-coded address data numbers are embedded using wobble signals;

FIG. 20 shows a relationship between decimal numbers, binary codes and Gray codes (Hamming weights of Gray codes);

FIG. 21 shows the structure of an optical disk apparatus according to an embodiment of the present invention;

FIG. 22 shows an example of the structure of an RF/WB/TE detector shown in FIG. 21;

FIG. 23 shows an example of the structure of an address reproducing unit 40 shown in FIG. 22; and

FIG. 24 shows another example of the structure of the address reproducing unit 40 shown in FIG. 22.

### DETAILED DESCRIPTION OF THE INVENTION

An embodiment of an optical disk apparatus according to the present invention will now be described with reference to the accompanying drawings.

To begin with, an optical disk of a land & groove recording type is described in brief. In the land & groove recording method, data is recorded on both a land track and a groove track. Thus, the neighboring land track and groove track have common wall surfaces. An n-th land track, as counted from the inner peripheral side of the optical disk, is referred to as “land track n”. Similarly, an n-th groove track, as counted from the inner peripheral side of the optical disk, is referred to as “groove track n”. The “groove track n” is located on the inner peripheral side of the “land track n”.

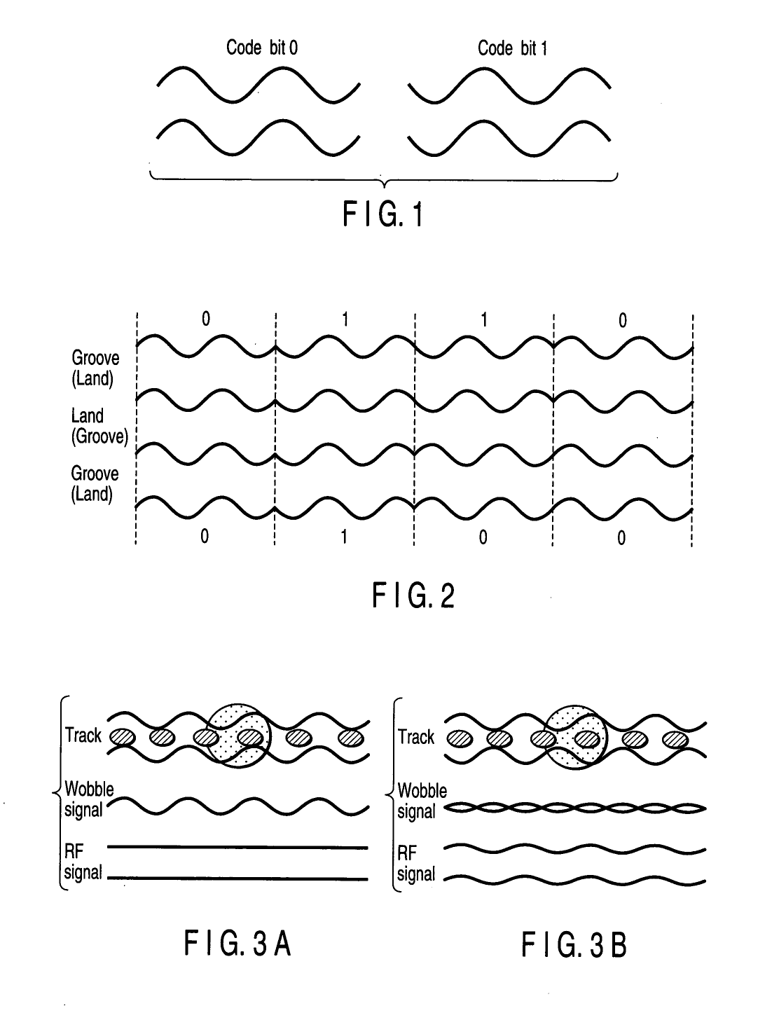

The “land track n” has an inner peripheral wall surface that is shared with the “groove track n”, and has an outer peripheral wall surface that is shared with a “groove track n+1”. Assume now that address data is recorded by the wobble modulation method, and the relationship between the code bits of address data and the wobble phases is as shown in FIG. 1. In this case, as shown in FIG. 2, the “land track n” may have a part where its inner peripheral wall surface and outer peripheral wall surface have different wobble phases, depending on the code bits of address data. In addition, in this part, the track width of the “land track n” varies.

Similarly, the “groove track n” has an inner peripheral wall surface that is shared with a “land track n−1”, and has an outer peripheral wall surface that is shared with the “land track n”. As shown in FIG. 2, the “land track n” may have a part where its inner peripheral wall surface and outer peripheral wall surface have different wobble phases, depending on the code bits of address data. In addition, in this part, the track width of the “groove track n” varies.

FIG. 3A and FIG. 3B show the states of wobble signals (address data) and data reproduction signals (RF signals) in cases where the phases of both wall surfaces of the track are the same and are different. As shown in FIG. 3A, in the case where both wall surfaces of the track wobble in the same phase, a wobble signal, which varies similarly with the variation of wobble of the wall surfaces, is detected, and an RF signal that is recorded on the track is read out as a signal having a substantially constant low-region level.

On the other hand, as shown in FIG. 3B, in the region where both wall surfaces of the track have different phases, the track width varies and the total reflection area of the read beam varies. Consequently, a DC offset occurs in the wobble signal and the RF signal has a waveform that wobbles in accordance with the wobble signal. In addition, since wobble signals corresponding to both wall surfaces have opposite phases, no signal is detected as the wobble signal (“no signal”). In fact, a signal with a small level is detected due to imbalance in a detector, a signal amplifier, and a differential detector, which is caused by an inclination of a light beam. However, the wobble signal phase that is detected at this time cannot be used as address data.

In the embodiment of the present invention, address data is Gray-coded and recorded on a land & groove recording-type optical disk by the wobble modulation method. When this optical disk is reproduced, (i) an uncertain bit position of land address data at a time of groove track reproduction is detected according to the rules of Gray codes, and the uncertain bit is replaced with a corresponding bit of groove address data, or (ii) an uncertain bit position of a groove address data at a time of land track reproduction is detected according to the rules of Gray codes, and the uncertain bit is replaced with a corresponding bit of land address data. Thereafter, an error in address data is detected on the basis of the groove address data and land address data. Alternatively, a track address is estimated from continuity of the track, and an error in address data is (i) detected or (ii) corrected (correct address data is found), on the basis of the groove address data, land address data and estimated address.

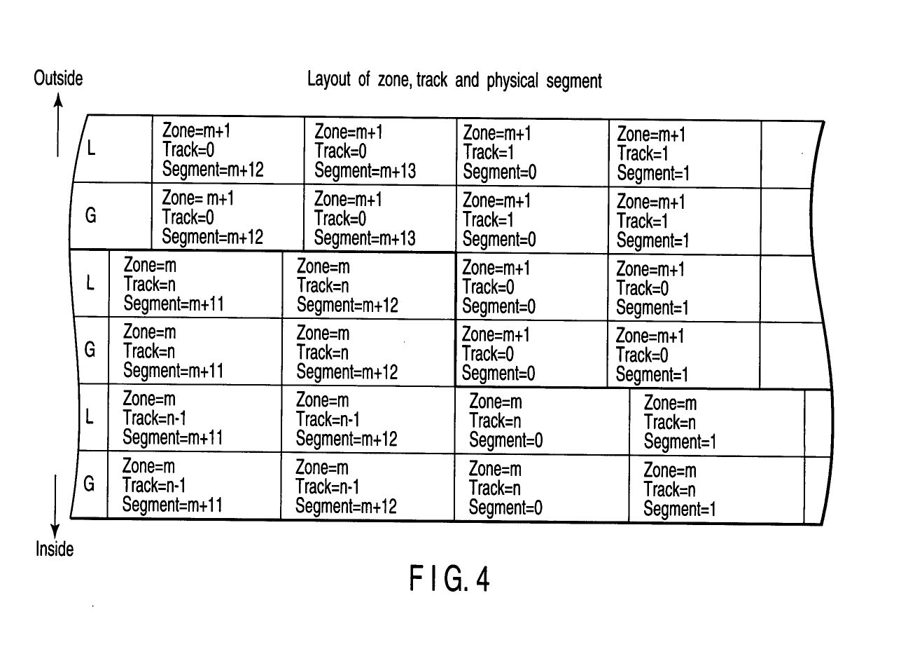

To begin with, the format of an optical disk according to the present embodiment is described. A track is divided into a plurality of physical segments, and a plurality of tracks form a zone. FIG. 4 shows a relationship between zones, tracks and physical segments. A boundary between zones is indicated by a heavy line. The length of the physical segment is 77469 bytes. 1 byte is 12 channel bits. As address data, a zone number, a track address and a segment number are assigned to each physical segment. The address data is recorded by phase-modulating wobbles.

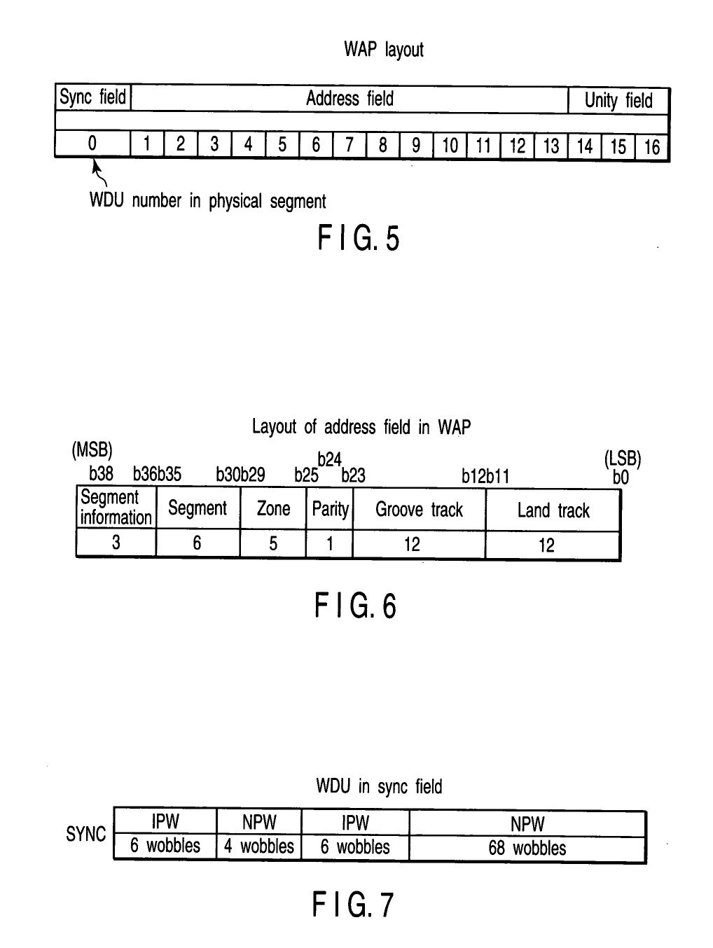

FIG. 5 shows a layout of address data (WAP) that is assigned to the physical segment. The address data includes a sync field, an address field and a unity field, and is divided into 17 wobble data units (WDU).

The address field is formed, as shown in FIG. 6. In the above-described land & groove recording method, neighboring land track and groove track have the common wall surface. Thus, an address field for the groove track and an address field for the land track are spatially discriminated. The groove track address data (b23-b12) and the land track address data (b11-b0) are recorded by Gray codes. The details of the Gray code will be described later.

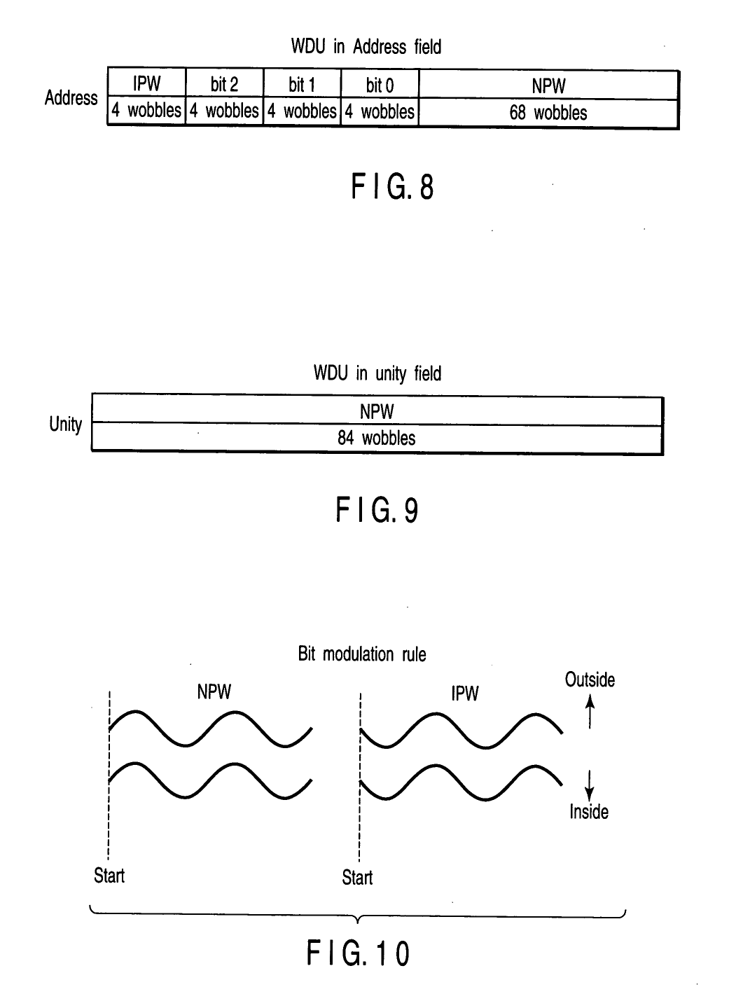

The wobble data unit (WDU) comprises 84 wobbles. The length of 1 wobble is 93 bytes. FIG. 7 to FIG. 9 show the structures of the WDU of the sync field, the WDU of the address field and the WDU of the unity field. In the WDU of the address field, 3-bit address data is recorded. At this time, normal-phase wobbles (NPW) are recorded for the code bit “0” of the address data, and inverted-phase wobbles (IPW) are recorded for the code bit “1” of the address data (FIG. 10).

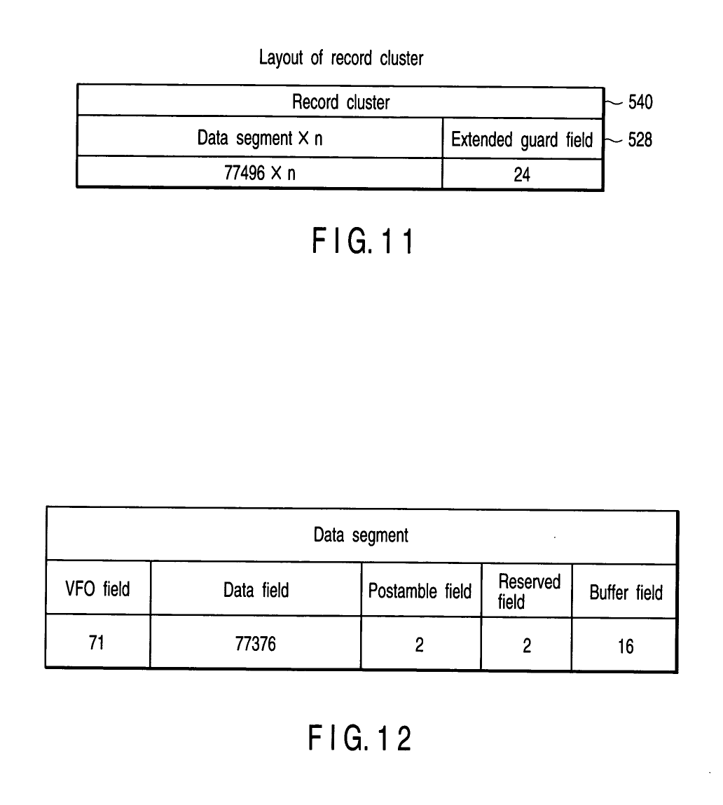

Data is recorded in units of a record cluster that is shown in FIG. 11. The record cluster comprises an n-number of data segments and an extension guard field. The length of the data segment is equal to the length of the physical segment and is 77469 bytes. The structure of the data segment is as shown in FIG. 12. In FIG. 12, the length of each field is expressed by the unit of “byte”. An ECC block is formed of data of 7 data segments.

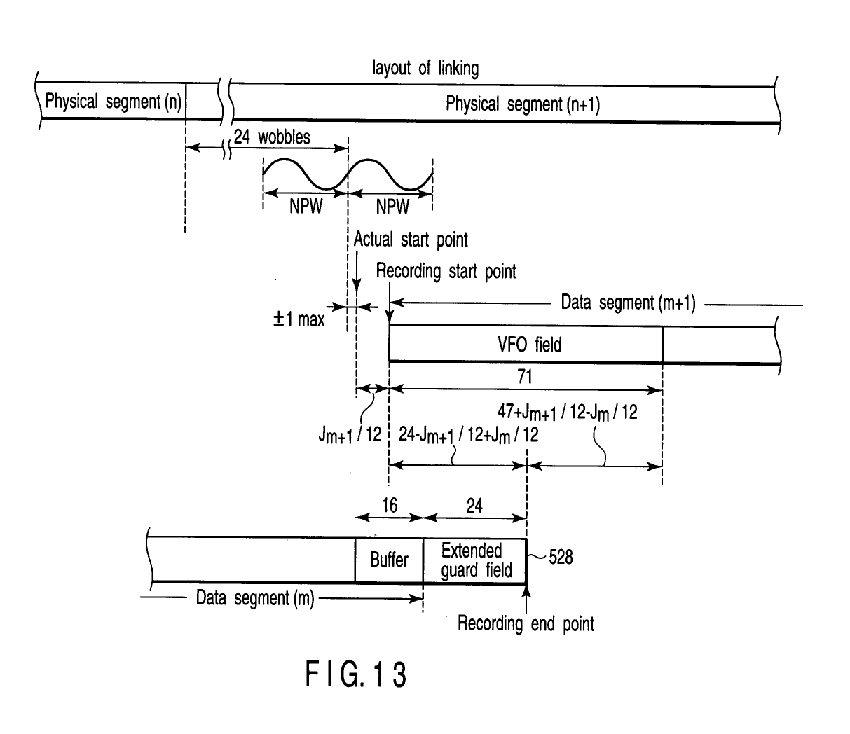

FIG. 13 shows the relationship between the record cluster and the physical segment. In FIG. 13, Jm and Jm+1 indicate random values in a range between 0 and 167. An extension guard field 528 and a subsequent VFO field 522 overlap, and an overlapping part occurs at a time of rewrite. The VFO field 522 in the data segment begins after 24 wobbles from the start of the physical segment. The extension guard field 528 is formed at the end of the record cluster that represents the rewrite unit. The random shift amount is set in a range that is greater than Jm/12 (0≦jm≦154).

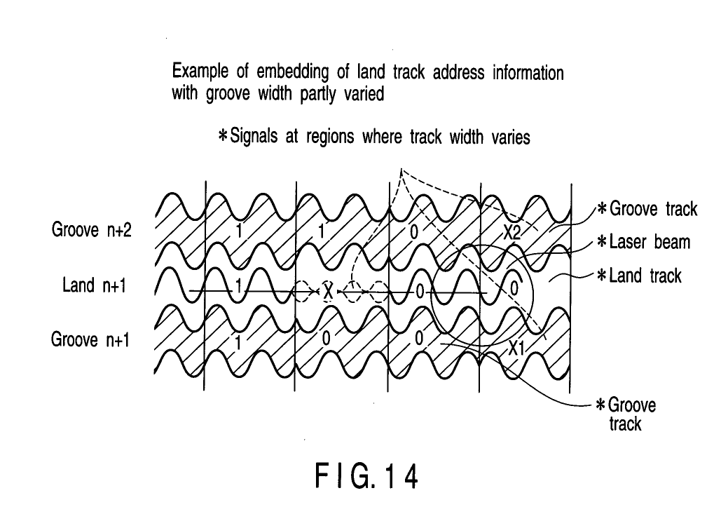

An (n+1)th land track, as counted from the inner peripheral side of the optical disk, is referred to as “land track n+1”. Similarly, an (n+1)th groove track, as counted from the inner peripheral side of the optical disk, is referred to as “groove track n+1”. The “groove track n+1” is located on the inner peripheral side of the “land track n+1”. At this time, attention is paid to the groove track address field of the “land track n+1”. As is shown in FIG. 14, this region has an inner peripheral wall surface that is shared with the “groove track n+1” and has an outer peripheral wall surface that is shared with a “groove track n+2”.

The track address is recorded with Gray codes. Thus, in the groove track address field of the physical segment of the land track, a track width for 1 address bit varies. Similarly, in the land track address field of the physical segment of the groove track, a track width for 1 address bit varies.

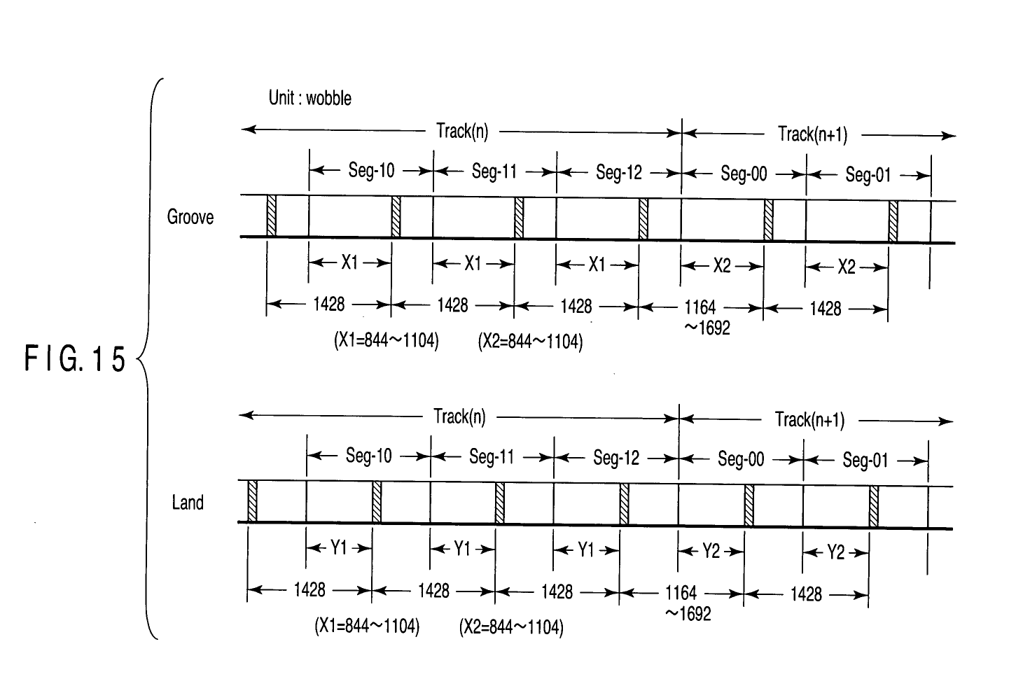

FIG. 15 shows a temporal correlation of address uncertain positions. An address uncertain position (indicated by hatching in FIG. 15) of 1 address bit is present in association with 1 physical segment. This position is set on a track-by-track basis. The ECC block, which is a data reproduction/recording block, is formed of 7 data segments. Thus, after the address uncertain position is detected, an error detection/elimination system that uses a segment flywheel counter can be employed. If an ECC block spans a connection part of tracks, the address uncertain position differs in the tracks since the track address is different. Hence, the temporal correlation varies with respect to the occurrence of a track width variation. An amount of displacement distance of the position, at which the track address varies, can be calculated in advance on the basis of the track address.

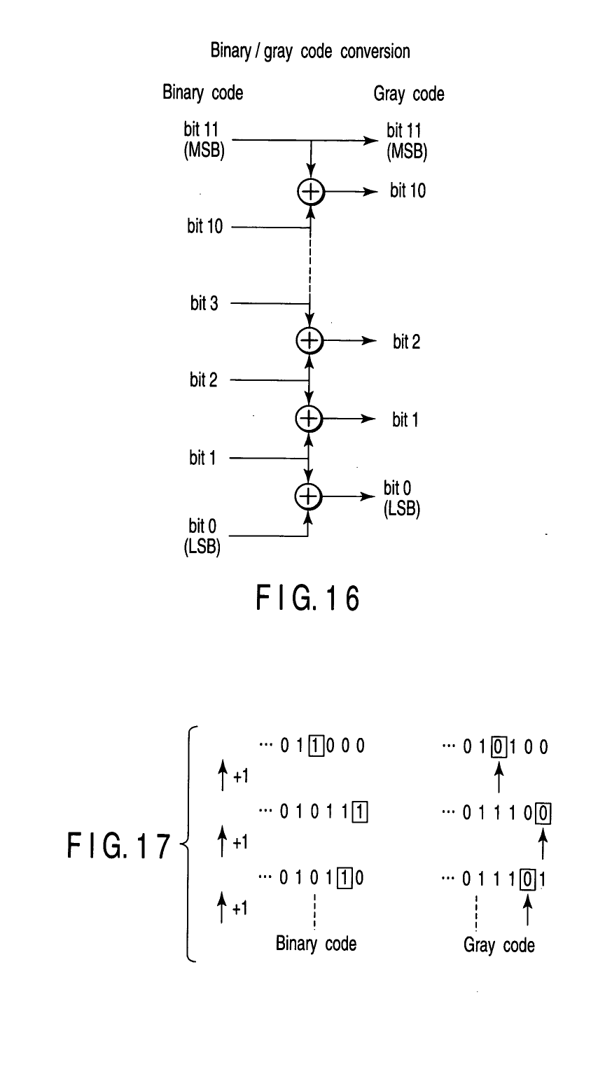

The track address, as described above, is recorded with Gray codes. The Gray code will now be explained. FIG. 16 illustrates conversion from binary codes to Gray codes. Gray codes are generated from EX-OR operation values of neighboring bits of binary codes in succession from the LSB. The MSB of the binary code is directly used as the MSB of the Gray code.

The Gray code, as illustrated in FIG. 17, is characterized in that when the binary code is incremented by +1, the bit content of the Gray code is different only with respect to 1 bit, and the other bits have the same values. In this case, the position of first “1”, as viewed from the LSB, in the binary code becomes the different bit position in the Gray code at which the bit content is different from a Gray code whose value is smaller by 1.

This relationship may be explained as follows. In the alternating binary ascending order of binary codes, when a given bit changes from “0” to “1”, the upper bit of this bit must be unchanged, and the lower bit of this bit must be changed from “1” to “0”.

The Gray code is an EX-OR value of a binary code of neighboring bits. Hence, if both neighboring bits of the binary code are changed, the EX-OR value thereof does not change. As a result, the relationship of the changed bit positions of the Gray codes and the relationship of the number of bits “1” of the converted Gray codes have the following characteristics.

(1) The first “1” bit position, as viewed from the LSB of the binary code is the changed bit position of the Gray code.

(2) When the value of the binary code is an odd value, the number (Hamming weight) of bits “1” of the Gray code is an odd number. When the value of the binary code is an even value, the number (Hamming weight) of bits “1” of the Gray code is an even number.

(3) In the ascending-order arrangement of Gray codes, the number of bits “1” in the code is a repetition from an even number to an odd number (since Gray codes are generated such that only 1 bit changes between neighboring Gray codes).

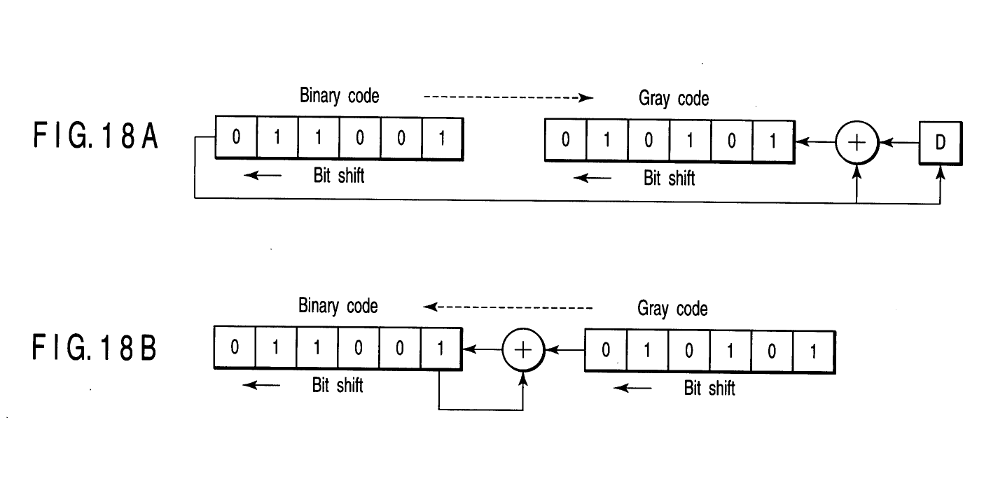

FIG. 18A shows an example of the circuit for converting a binary code (track address) to a Gray code. FIG. 18B shows an example of the circuit for converting (demodulating) a Gray code to a binary code. With this structure, when 1-bit progressive address data is converted to a Gray code, the position of change of 1 bit can easily be detected.

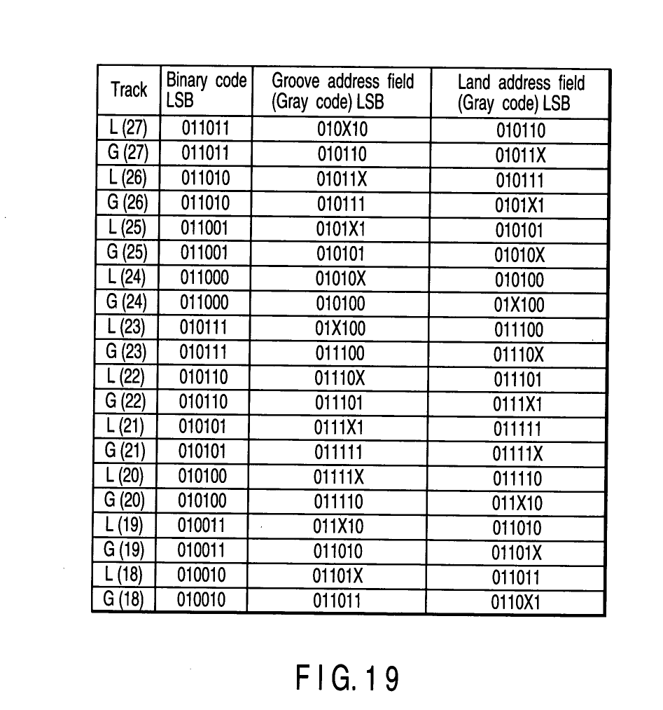

When Gray codes are applied to the track addresses of the land & groove recording scheme, track addresses of land & groove tracks are assigned ascending-order track numbers for grooves and lands from the inner peripheral side toward the outer peripheral side, and are recorded as address data along with zone numbers and segment numbers. Although the actually used address bit number is 12 bits, FIG. 19 shows a relationship in the case where the track address alone is expressed by 6 bits of the Gray code.

FIG. 19 shows a relationship between an address uncertain position and address data (binary code) in a case where Gray-coded address data is embedded using wobble signals. In the Gray code, “X” indicates an uncertain bit of the wobble signal. The bit “X” is theoretically a signal “0”, but in the actual reproducing operation a small signal level is detected due to a tracking error of a read beam or an offset of the detector. The polarity of detection in this case varies depending on the condition of the offset, etc., and the bit “X” is an uncertain bit in a prior judgment. At the uncertain bit, the detection signal has no reliability and cannot be used for data judgment. However, the Gray code has a feature that only 1 bit varies between neighboring Gray codes, and this bit becomes an uncertain bit. Thus, other bits are usable for a check, etc. If the correct position of the uncertain bit is detected, the reliability of detection can be improved in the land track by using the land address data and the groove address data that excludes the uncertain bit. FIG. 19 shows, by way of example, track addresses 18 to 27 in the case where the track address is 6 bits.

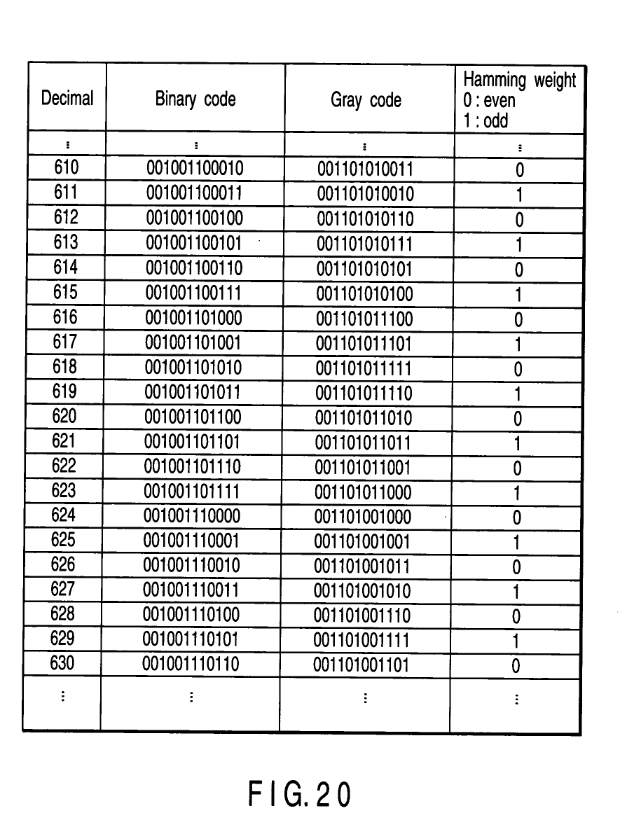

As has been described above, the track addresses increase from the inner peripheral side toward the outer peripheral side, and the groove track is arranged inside the land track of the same track address. Assuming that the even/odd number of the sum of “1”s in the Gray code is a Hamming weight, the Hamming weight of the Gray code is the same as the even/odd number of the decimal system, as shown in FIG. 20. Based on the above items, the address uncertain position of the Gray code can be found with the following relationships.

(1) In the case of the land track:

In the case where the Hamming weight of the binary code of the land address is an even number, the first bit (LSB), as counted from the LSB of the groove address data, corresponds to the address uncertain position. In the case where the Hamming weight of the binary code of the land address is an odd number, the (n+1)th bit, as counted from the LSB of the groove address data, corresponds to the address uncertain position, the “n” being the bit position of the first code bit “1” as viewed from the LSB of the land address data.

(2) In the case of the groove track:

In the case where the Hamming weight of the binary code of the groove address is an odd number, the first bit (LSB), as counted from the LSB of the land address data, corresponds to the address uncertain position. In the case where the Hamming weight of the binary code of the groove address is an even number, the (n+1)th bit, as counted from the LSB of the land address data, corresponds to the address uncertain position, the “n” being the bit position of the first code bit “1” as viewed from the LSB of the groove address data.

Since the above relationships are established, the address uncertain position can easily be specified from the Gray code. As shown in FIG. 6, the address information that is assigned to the physical segment includes the groove track address field and the land track address field. Thus, the bit at the address uncertain position of the specified groove track (land track) address field can be replaced with the bit at the corresponding position of the land track (groove track) address field. According to the present embodiment, it is considered that the address data is doubly written in the groove track (or land track) address field.

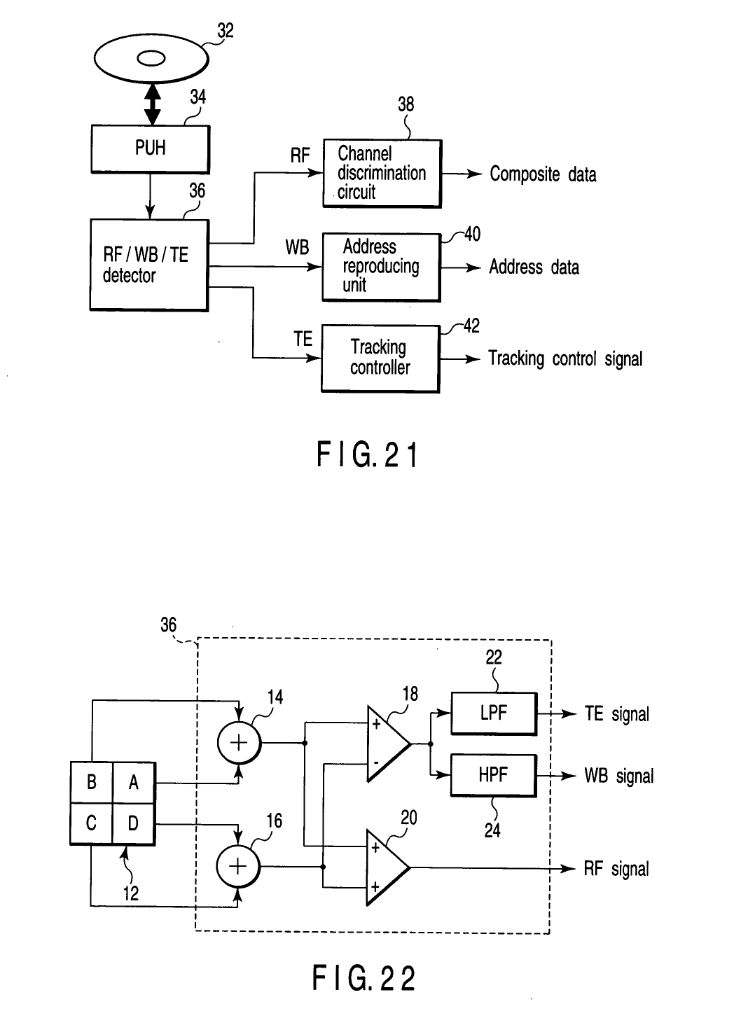

FIG. 21 shows the structure of an optical disk apparatus according to the present embodiment. A signal that is read out of an optical disk 32 is supplied to an RF/WB/TE detector 36 via a pick-up head (PUH) 34. The RF/WB/TE detector 36 detects a reproduction signal RF, a wobble signal WB and a tracking error signal TE. A channel system discrimination circuit 38 reproduces data, which is recorded on the optical disk, from the RF signal, and outputs the decoded signal (binary data) to a rear-stage circuit (not shown). An address reproducing unit 40 reproduces a position on the optical disk, that is, address data, from the WB signal, and outputs the address data to a rear-stage circuit (not shown). A tracking controller 42 generates a tracking control signal from the TE signal and outputs it to a rear-stage circuit (not shown).

FIG. 22 shows the detailed structure of the RF/WB/TE signal detector 36 that detects the tracking error signal TE, wobble signal WB and reproduction signal RF from the output signals from a 4-division optical detector 12 that is provided in the pickup head 34, which reads out the signal from the optical disk. Outputs from elements A and B of the 4-division optical detector 12 are supplied to an adder 14, and outputs from elements C and D are supplied to an adder 16. An output of the adder 14 is supplied to a non-inversion input terminal (+) of each of differential amplifiers 18 and 20, and an output of the adder 16 is supplied to an inversion input terminal (−) of each of differential amplifiers 18 and 20. An output of the differential amplifier 18 is produced as a tracking error signal TE via a low-pass filter 22, and is also produced as a wobble signal WB via a high-pass filter 24. An output of the differential amplifier 20 is produced as a reproduction signal RF.

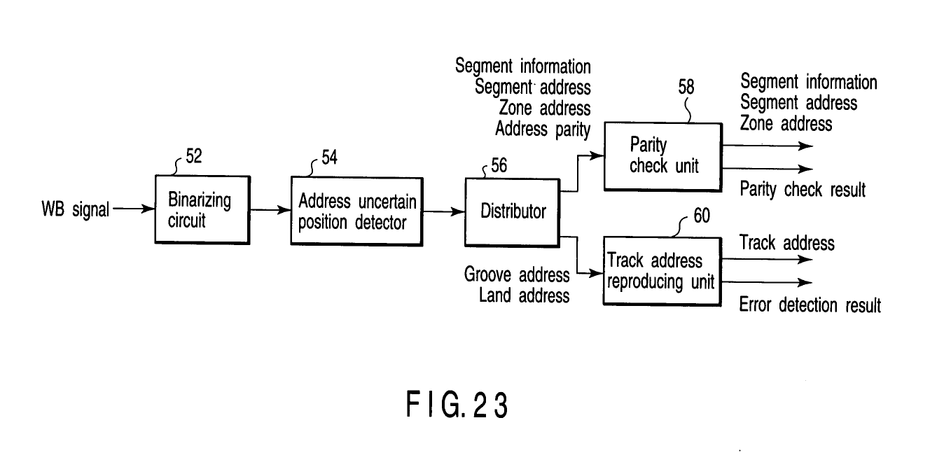

FIG. 23 is a block diagram that shows an example of the address reproducing unit 40. The analog WB signal is converted to address data (Gray code) by a binarizing circuit 52 that includes a PLL circuit. An address uncertain position detector 54 detects the address uncertain position of the land (groove) address according to the above-described principle for detection of the address uncertain position and replaces the bit at the detected address uncertain position with the bit of the corresponding groove (land) address. Specifically, while the groove (land) track is being reproduced, the 1-bit address uncertain position is present in the land (groove) address data. The bit at the address uncertain position is replaced with the corresponding bit of the groove (land) address data.

The address data in which the replacement is executed is supplied to a distributor 56. The segment information, segment address, zone address and address parity (see FIG. 6) in the address field are supplied to a parity check unit 58, and track addresses (groove track address and land track address) are supplied to a track address reproducing unit 60. The parity check unit 58 outputs the segment information, segment address and zone address, and executes a parity check and outputs a parity check result. The track address reproducing unit 60 demodulates the land address and groove address (i.e. converts the Gray codes to the binary codes). Then, at the time of land (groove) track reproduction, the track address reproducing unit 60 outputs the land (groove) address data as a track address. In addition, the track address reproducing unit 60 checks whether the groove address data and land address data agree or not, and outputs a check result as an error detection result.

The address data that is recorded by the wobble signal may erroneously be detected due to a scratch or other defects. However, by arranging the land address and groove address in the address field of the same track and comparing both addresses, malfunction due to erroneous detection can be prevented.

In the present embodiment, the address uncertain position detector 54 is arranged immediately after the binarizing circuit 52. Alternatively, the address uncertain position detector 54 may be arranged before the track address reproducing unit 60 or within the track address reproducing unit 60.

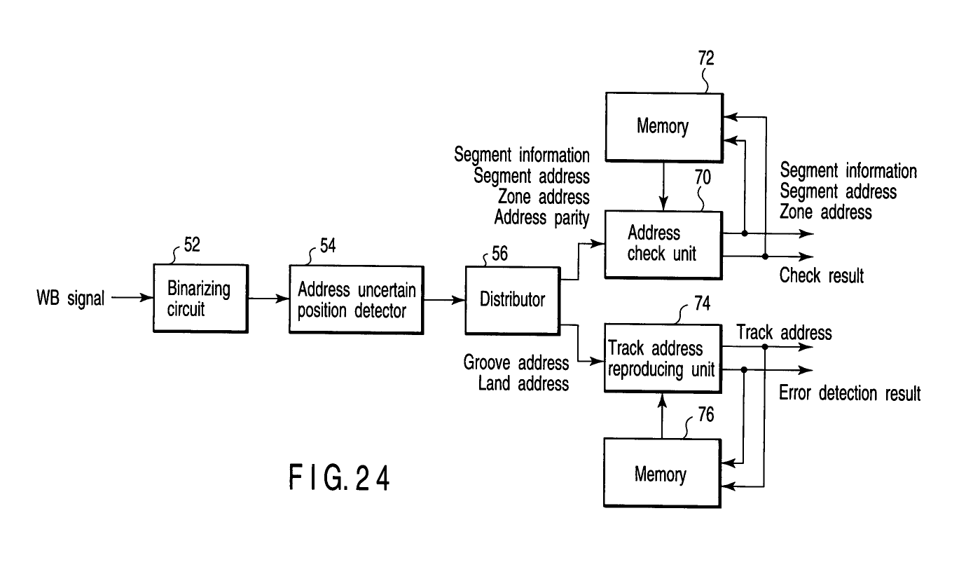

FIG. 24 is a block diagram that shows another example of the address reproducing unit 40. The optical disk has spiral record tracks, and address data is reproduced along the spiral tracks. Thus, based on the continuity of the address data, the next address data can be estimated. A track address reproducing unit 74 shown in FIG. 24 is characterized by using such estimated address data. The operations and functions of the binarizing circuit 52, address uncertain position detector 54 and distributor 56 are the same as in the case of FIG. 23. The distributor 56 supplies the segment information, segment address, zone address and address parity to an address check unit 70, and supplies the track addresses to the track address reproducing unit 74.

The address check unit 70 stores the previously output (immediately preceding) segment information, segment address, zone address and parity check result in a memory 72, and finds the present-time segment information, segment address, zone address and parity check result using the stored data. Similarly, the track address reproducing unit 74 stores the previously output track address and track address error detection result in a memory 76, and finds the present-time track address and track address error detection result using the stored data.

The address check unit 70 executes the following operation. Assume that the present-time segment information, segment address and zone address are SI, PH and ZO, and estimated values of the next segment information, segment address and zone address are SI′, PH′ and ZO′. The address check unit 70 outputs SI, PH and ZO.

(1) At the time when the previous check result (stored in memory 72) is “Low” (no error):

In the case where SI=SI′, PH=PH′ and ZO=ZO′ and no error is detected by the address parity, the present-time check result is set to be “Low”. In other cases, the present-time check result is set to be “High” (presence of error).

(2) At the time when the previous check result is “High”:

If no error is detected by the address parity, the present-time check result is set to be “Low”. In other cases, the present-time check result is set to be “High”.

In other words, an error is detected using the estimated address only in the case where the previous-time check result indicates no error. In the case where the previous-time check result indicates an error, the reliability of the estimated address is low and thus the estimated address is not used for error detection.

The track address reproducing unit 74 executes the following operation. Assume that the groove address data, land address data and estimated track address are GTr, LTr and Tr′.

### EXAMPLE 1 OF OPERATION

When the groove (land) track is reproduced, GTr (LTr) is output as the track address.

(1) At the time when the previous error detection result (stored in memory 76) is “Low” (no error):

When GTr=LTr=Tr′, the error detection result is set to be “Low”. In other cases, the error detection result is set to be “High” (presence of error).

(2) At the time when the previous error detection result is “High”:

When GTr=LTr, the error detection result is set to be “Low”. In other cases, the error detection result is set to be “High”.

The operation of the track address reproducing unit 74 is not limited to the above, and the following operations may be executed.

### EXAMPLE 2 OF OPERATION

(1) At the time when the previous error detection result is “Low”:

When GTr=Tr′ or LTr=Tr′, the error detection result is set to be “Low”. In other cases, the error detection result is set to be “High” (presence of error). In any case, Tr′ is output as the track address.

(2) At the time when the previous error detection result is “High”:

When GTr=LTr, the error detection result is set to be “Low”. In other cases, the error detection result is set to be “High”. When the groove (land) track is reproduced, GTr (LTr) is output as the track address.

### EXAMPLE 3 OF OPERATION

(1) At the time when the previous error detection result is “Low”:

If at least two of GTr, LTr and Tr′ agree, the error detection result is set to be “Low”. In other cases, the error detection result is set to be “High”. The track address is output in accordance with the decision by majority of the bits of GTr, LTr and Tr′.

(2) At the time when the previous error detection result is “High”:

When GTr=LTr, the error detection result is set to be “Low”. In other cases, the error detection result is set to be “High”. When the groove (land) track is reproduced, GTr (LTr) is output as the track address.

The operation mode of the track address reproducing unit 74 is variable depending on the purpose of use, that is, depending on the level of requirement for the track address. For example, at the time of data recording, Example 1 of Operation is adopted. At the time of data reproduction, Example 2 or 3 of Operation may be adopted.

In the present embodiment, the address uncertain position detector 54 is arranged immediately after the binarizing circuit 52. Alternatively, the address uncertain position detector 54 may be arranged before the track address reproducing unit 74 or within the track address reproducing unit 74.

As has been described above, according to the present embodiment, the address data uncertain position of the track address can be detected on the basis of the rules of Gray codes.

The bit at the address uncertain position of the detected groove address is replaced with the corresponding bit of the corresponding land address. In addition, the bit at the address uncertain position of the detected land address is replaced with the corresponding bit of the corresponding groove address. By comparing both addresses, an error of the track address can be detected.

Further, the bit at the address uncertain position of the detected groove address is replaced with the corresponding bit of the corresponding land address. The bit at the address uncertain position of the detected land address is replaced with the corresponding bit of the corresponding groove address. On the basis of three addresses, i.e. both addresses and an address that is estimated in accordance with the continuity of track addresses, an error of the track address can be detected and corrected. Specifically, when the land (groove) track is reproduced, in the case where the Hamming weight of the Gray code of the land (groove) address is an even (odd) number, the LSB of the groove (land) address is set as the address uncertain position. In the case where the Hamming weight of the Gray code of the land (groove) address is an odd (even) number, the bit position of the least significant code bit “1” of the land (groove) address is set as n and the (n+1)th bit, as viewed from the LSB of the groove (land) address data, is detected as the address uncertain position. Thus, it is possible to provide an optical disk apparatus and an address detection method, wherein the address data can correctly be reproduced from the land & groove recording-type optical disk, on which the address data is Gray-coded using the wobble modulation scheme, and the address data can correctly be reproduced from the land & groove recording scheme optical disk, on which the address data is recorded using the wobble modulation scheme.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

1. An optical disk apparatus which detects a track address from an optical disk of a land & groove recording type, on which a Gray code of a track address that includes a land address and a groove address is wobble-modulated and recorded, the apparatus comprising:
Gray code detection means for detecting the Gray code of the track address;
position detection means for detecting an address uncertain position of the Gray code of the track address, which is detected by the Gray code detection means, based on a rule of a Gray code; and
means for replacing a bit at the address uncertain position of the land address, which is detected by the position detection means, with a bit at a corresponding position of the groove address that is recorded on the same track, and replacing a bit at the address uncertain position of the groove address, which is detected by the position detection means, with a bit at a corresponding position of the land address that is recorded on the same track.

2. The optical disk apparatus according to claim 1, wherein the position detection means comprises means for detecting, as an address uncertain position, one of a least significant bit of the Gray code of the track address that is detected by the Gray code detection means and a bit of the Gray code of the track address that is detected by the Gray code detection means and is higher by one than a bit position of a least significant code bit “1”.

3. The optical disk apparatus according to claim 2, wherein at the time of land track reproduction, the position detection means detects the least significant bit of the Gray code of the groove address as the address uncertain position if a Hamming weight of the Gray code of the land address is an even number, and the position detection means detects an (n+1)th bit, as counted from the least significant bit of the groove address, as the address uncertain position, where n indicates a bit position of a least significant code bit “1” of the Gray code of the land address, if the Hamming weight of the Gray code of the land address is an odd number, and
at the time of reproduction of a groove track of the same track address at an inner peripheral side of said land track, the position detection means detects the least significant bit of the Gray code of the land address as the address uncertain position if a Hamming weight of the Gray code of the groove address is an odd number, and the position detection means detects an (n+1)th bit, as counted from the least significant bit of the land address, as the address uncertain position, where n indicates a bit position of a least significant code bit “1” of the Gray code of the groove address, if the Hamming weight of the Gray code of the groove address is an even number.

4. The optical disk apparatus according to claim 3, further comprising error detection means for comparing the land address and the groove address of the same track, thereby detecting an error of the track address.

5. The optical disk apparatus according to claim 3, further comprising:
means for obtaining an estimated track address based on a continuity of the track address; and
error detection & correction means for comparing the land address and the groove address of the same track and the estimated track address, thereby detecting and correcting an error of the track address.

6. The optical disk apparatus according to claim 5, wherein at the time of land track reproduction, the position detection means detects the least significant bit of the Gray code of the groove address as the address uncertain position if a Hamming weight of the Gray code of the land address is an even number, and the position detection means detects an (n+1)th bit, as counted from the least significant bit of the groove address, as the address uncertain position, where n indicates a bit position of a least significant code bit “1” of the Gray code of the land address, if the Hamming weight of the Gray code of the land address is an odd number, and
at the time of reproduction of a groove track of the same track address at an inner peripheral side of said land track, the position detection means detects the least significant bit of the Gray code of the land address as the address uncertain position if a Hamming weight of the Gray code of the groove address is an odd number, and the position detection means detects an (n+1)th bit, as counted from the least significant bit of the land address, as the address uncertain position, where n indicates a bit position of a least significant code bit “1” of the Gray code of the groove address, if the Hamming weight of the Gray code of the groove address is an even number.

7. An optical disk apparatus which detects a track address from an optical disk of a land & groove recording type, on which the track address that includes a land address and a groove address is wobble-modulated and recorded, the apparatus comprising:
detection means for detecting the track address;
means for obtaining an estimated track address based on a continuity of the track address; and
error detection means for comparing the detected track address and the estimated track address, thereby detecting an error of the track address.

8. A method for detecting a track address from an optical disk of a land & groove recording type, on which a Gray code of a track address that includes a land address and a groove address is wobble-modulated and recorded, the method comprising:
detecting the Gray code of the track address;
detecting an address uncertain position of the detected Gray code of the track address based on a rule of a Gray code;
replacing a bit at the address uncertain position of the land address with a bit at a corresponding position of the groove address that is recorded on the same track, and replacing a bit at the address uncertain position of the groove address with a bit at a corresponding position of the land address that is recorded on the same track.

9. The track address detecting method according to claim 8, wherein the detecting an address uncertain position comprises detecting, as an address uncertain position, one of a least significant bit of the detected Gray code of the track address and a bit of the detected Gray code of the track address and is higher by one than a bit position of a least significant code bit “1”.

10. The method according to claim 9, wherein at the time of land track reproduction, the position detecting comprises detecting the least significant bit of the Gray code of the groove address as the address uncertain position if a Hamming weight of the Gray code of the land address is an even number, and the position detecting comprises detecting an (n+1)th bit, as counted from the least significant bit of the groove address, as the address uncertain position, where n indicates a bit position of a least significant code bit “1” of the Gray code of the land address, if the Hamming weight of the Gray code of the land address is an odd number, and
at the time of reproduction of a groove track of the same track address at an inner peripheral side of said land track, the position detecting comprises detecting the least significant bit of the Gray code of the land address as the address uncertain position if a Hamming weight of the Gray code of the groove address is an odd number, and the position detecting comprises detecting an (n+1)th bit, as counted from the least significant bit of the land address, as the address uncertain position, where n indicates a bit position of a least significant code bit “1” of the Gray code of the groove address, if the Hamming weight of the Gray code of the groove address is an even number.

11. The track address detecting method according to claim 10, further comprising comparing the land address and the groove address of the same track, thereby detecting an error of the track address.

12. The method according to claim 8, further comprising:
obtaining an estimated track address based on a continuity of the track address; and
comparing the land address and the groove address of the same track and the estimated track address, thereby detecting and correcting an error of the track address.

13. The method according to claim 12, wherein at the time of land track reproduction, the position detecting comprises detecting the least significant bit of the Gray code of the groove address as the address uncertain position if a Hamming weight of the Gray code of the land address is an even number, and the position detecting comprises detecting an (n+1)th bit, as counted from the least significant bit of the groove address, as the address uncertain position, where n indicates a bit position of a least significant code bit “1” of the Gray code of the land address, if the Hamming weight of the Gray code of the land address is an odd number, and
at the time of reproduction of a groove track of the same track address at an inner peripheral side of said land track, the position detecting comprises detecting the least significant bit of the Gray code of the land address as the address uncertain position if a Hamming weight of the Gray code of the groove address is an odd number, and the position detecting comprises detecting an (n+1)th bit, as counted from the least significant bit of the land address, as the address uncertain position, where n indicates a bit position of a least significant code bit “1” of the Gray code of the groove address, if the Hamming weight of the Gray code of the groove address is an even number.

14. A method for detecting a track address from an optical disk of a land & groove recording type, on which a track address that includes a land address and a groove address is wobble-modulated and recorded, the method comprising:
detecting the track address;
obtaining an estimated track address based on a continuity of the track address; and
comparing the detected track address and the estimated track address, thereby detecting an error of the track address.
